(19) United States
(12) Patent Application Publication
(10) Pub. No.: US 2024/0007598 A1
(43) Pub. Date: Jan. 4, 2024

(54) PROJECTION SYSTEM AND CONTROL METHOD THEREOF

(71) Applicant: Coretronic Corporation, Hsin-Chu (TW)

(72) Inventors: Pei-Jen Liao, Hsin-Chu (TW); Chih En Wang, Hsin-Chu (TW); Hsin-Chang Huang, Hsin-Chu (TW); Chien-Yi Yang, Hsin-Chu (TW)

(73) Assignee: Coretronic Corporation, Hsin-Chu (TW)

(21) Appl. No.: 18/331,162

(22) Filed: Jun. 7, 2023

(30) Foreign Application Priority Data
Jun. 30, 2022 (CN) 202210778477.7

(51) Int. Cl. H04N 9/31; H05B 47/115

(52) U.S. Cl. CPC H04N 9/312; H05B 47/115

(57) ABSTRACT

A projection system and a control method thereof are provided. The projection system includes a projection module, a mmWave sensor, and a control circuit. The projection module projects an image beam to a projection surface. The mmWave sensor is configured to sense an object entering a sensing range and obtain a sensing result. The control circuit is coupled to the projection module and the mmWave sensor, and the control circuit controls the projection module to provide the image beam according to the sensing result of the mmWave sensor.

### CROSS-REFERENCE TO RELATED APPLICATION

This application claims the priority benefit of China application serial no. 202210778477.7 filed on Jun. 30, 2022. The entirety of the above-mentioned patent application is hereby incorporated by reference herein and made a part of this specification.

### BACKGROUND OF THE INVENTION

### Field of the Invention

The invention relates to a display device, and more particularly, to a projection system and a control method thereof.

### Description of Related Art

In the case of using a projection system, if people or animals enter the projection range of the projection system unintentionally, they may be irradiated by the image beam emitted by the projection system, thereby causing harm to the eyes.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides a projection system and a control method thereof that may improve the use safety of the projection system.

Other objects and advantages of the invention may be further understood from the technical features disclosed in the invention.

To achieve one or part or all of the above objects or other objects, a projection system of the invention includes a projection module, a mmWave sensor, and a control circuit. The projection module is configured to project an image beam to a projection surface. The mmWave sensor is configured to sense an object entering a sensing range and obtain a sensing result. The control circuit is coupled to the projection module and the mmWave sensor, and the control circuit is configured to control the projection module to provide the image beam according to the sensing result of the mmWave sensor.

In an embodiment of the invention, the control circuit includes a logic circuit and a light source driving circuit. The logic circuit is coupled to the mmWave sensor, and the logic circuit is configured to output an enable control signal according to the sensing result of the mmWave sensor. The light source driving circuit is coupled to the logic circuit and the projection module, and the light source driving circuit is configured to drive the projection module to provide the image beam according to the enable control signal.

In an embodiment of the invention, the logic circuit includes a first AND gate and a second AND gate. The first AND gate includes a first input terminal and a first output terminal, the first input terminal is coupled to the mmWave sensor, and the first AND gate is configured to output a logic signal according to the sensing result of the mmWave sensor. The second AND gate includes a second input terminal and a second output terminal, the second input terminal is coupled to the first output terminal of the first AND gate, the second output terminal is coupled to the light source driving circuit, and the second AND gate is configured to output the enable control signal according to the logic signal.

In an embodiment of the invention, the second AND gate further includes a third input terminal, and the control circuit further includes a projection control circuit. The projection control circuit is coupled to the projection module and the third input terminal, the projection control circuit is configured to output a first control signal to the second AND gate according to a working state of the projection module, and the second AND gate outputs the enable control signal according to the logic signal from the first AND gate and the first control signal.

In an embodiment of the invention, the projection system further includes a distance sensor coupled to the control circuit, and the distance sensor is configured to sense a distance between the projection module and the projection surface. The control circuit outputs a distance signal to the mmWave sensor according to the distance, and the mmWave sensor adjusts the sensing range from a first sensing range to a second sensing range according to the distance signal.

In an embodiment of the invention, the mmWave sensor adjusts a transmission power from a first transmission power to a second transmission power according to the distance signal.

In an embodiment of the invention, the control circuit adjusts the sensing range of the mmWave sensor according to a sensing range adjustment command.

In an embodiment of the invention, the mmWave sensor has a state indication value, the control circuit is configured to determine whether a state of the mmWave sensor is abnormal according to the state indication value, and the control circuit controls the projection module to provide the image beam according to the state indication value and the sensing result of the mmWave sensor.

In an embodiment of the invention, when the state of the mmWave sensor is abnormal, or the sensing result of the mmWave sensor is that the object enters the sensing range, the control circuit controls the projection module to stop providing the image beam.

In an embodiment of the invention, the control circuit includes a processing circuit, a logic circuit, and a light source driving circuit. The processing circuit is coupled to the mmWave sensor, and the processing circuit is configured to output a second control signal according to the state indication value. The logic circuit is coupled to the mmWave sensor and the processing circuit, and the logic circuit is configured to output an enable control signal according to the sensing result of the mmWave sensor and the second control signal. The light source driving circuit is coupled to the logic circuit and the projection module, and the light source driving circuit is configured to drive the projection module to provide the image beam according to the enable control signal.

In an embodiment of the invention, the logic circuit includes a first AND gate and a second AND gate. The first AND gate includes a first input terminal, a fourth input terminal, and a first output terminal. The first input terminal is coupled to the mmWave sensor, the fourth input terminal is coupled to the processing circuit, and the first AND gate is configured to output a logic signal according to the sensing result of the mmWave sensor and the second control signal. The second AND gate includes a second input terminal and a second output terminal, the second input terminal is coupled to the first output terminal of the first AND gate, the second output terminal is coupled to the light source driving circuit, and the second AND gate is configured to output the enable control signal according to the logic signal.

In an embodiment of the invention, the mmWave sensor includes a register, and the register is configured to store the state indication value.

In an embodiment of the invention, the projection system further includes a casing, the mmWave sensor is disposed in the casing, and the casing does not have an opening corresponding to a position where the mmWave sensor is disposed.

The invention also provides a control method of a projection system. Whether an object enters a sensing range is sensed via a mmWave sensor, and a sensing result is obtained. A projection module is controlled to provide an image beam according to the sensing result of the mmWave sensor via a control circuit.

In an embodiment of the invention, the control circuit includes a logic circuit and a light source driving circuit. The control method of the projection system includes the following steps. An enable control signal is output according to the sensing result of the mmWave sensor via the logic circuit. The projection module is driven to provide the image beam according to the enable control signal via the light source driving circuit.

In an embodiment of the invention, the logic circuit includes a first AND gate and a second AND gate. The control method of the projection system includes the following steps. A logic signal is output according to the sensing result of the mmWave sensor via the first AND gate. The enable control signal is output according to the logic signal via the second AND gate.

In an embodiment of the invention, the control circuit further includes a projection control circuit. The control method of the projection system includes the following steps. A first control signal is output to the second gate AND gate according to a working state of the projection module via the projection control circuit. The enable control signal is output according to the logic signal from the first AND gate and the first control signal via the second AND gate.

In an embodiment of the invention, the control method of the projection system includes the following steps. A distance between the projection module and a projection surface is sensed via a distance sensor. A distance signal is output to the mmWave sensor according to the distance via the control circuit. The sensing range is adjusted from a first sensing range to a second sensing range according to the distance signal via the mmWave sensor.

In an embodiment of the invention, the control method of the projection system includes adjusting a transmission power from a first transmission power to a second transmission power according to the distance signal via the mmWave sensor.

In an embodiment of the invention, the control method of the projection system includes adjusting the sensing range of the mmWave sensor according to a sensing range adjustment command via the control circuit.

In an embodiment of the invention, the control method of the projection system includes the following steps. Whether a state of the mmWave sensor is abnormal is determined according to a state indication value of the mmWave sensor via the control circuit. The projection module is controlled to provide the image beam according to the state indication value and the sensing result of the mmWave sensor via the control circuit.

In an embodiment of the invention, the control method of the projection system includes controlling the projection module to stop providing the image beam via the control circuit when the state of the mmWave sensor is abnormal, or the sensing result of the mmWave sensor is that the object enters the sensing range.

In an embodiment of the invention, the control circuit includes a processing circuit, a logic circuit, and a light source driving circuit. The control method of the projection system includes the following steps. A second control signal is output according to the state indication value via the processing circuit. An enable control signal is output according to the sensing result of the mmWave sensor and the second control signal via the logic circuit. The projection module is driven to provide the image beam according to the enable control signal via the light source driving circuit.

In an embodiment of the invention, the logic circuit includes a first AND gate and a second AND gate. The control method of the projection system includes the following steps. A logic signal is output according to the sensing result of the mmWave sensor and the second control signal via the first AND gate. The enable control signal is output according to the logic signal via the second AND gate.

Based on the above, the control circuit of the invention may control the projection module to provide the image beam according to the sensing result of the mmWave sensor. When a person or an animal enters the sensing range of the mmWave sensor, the control circuit may control the projection module to stop providing the image beam, so as to prevent the image beam from causing damage to the eyes of humans or animals, thereby improving the use safety of the projection system.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection system according to an embodiment of the invention.

FIG. 2 is a schematic diagram of a projection system according to another embodiment of the invention.

FIG. 3 is a schematic diagram of a projection system according to another embodiment of the invention.

FIG. 4 is a schematic diagram of a projection system according to another embodiment of the invention.

FIG. 5 is a schematic diagram of adjusting a sensing range of a mmWave sensor according to an embodiment of the invention.

FIG. 6 is a flowchart of a control method of a projection system according to an embodiment of the invention.

FIG. 7 is a flowchart of a control method of a projection system according to another embodiment of the invention.

FIG. 8 is a flowchart of a control method of a projection system according to another embodiment of the invention.

FIG. 9 is a flowchart of a control method of a projection system according to another embodiment of the invention.

FIG. 10 is a flowchart of a control method of a projection system according to another embodiment of the invention.

FIG. 11 is a flowchart of a control method of a projection system according to another embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

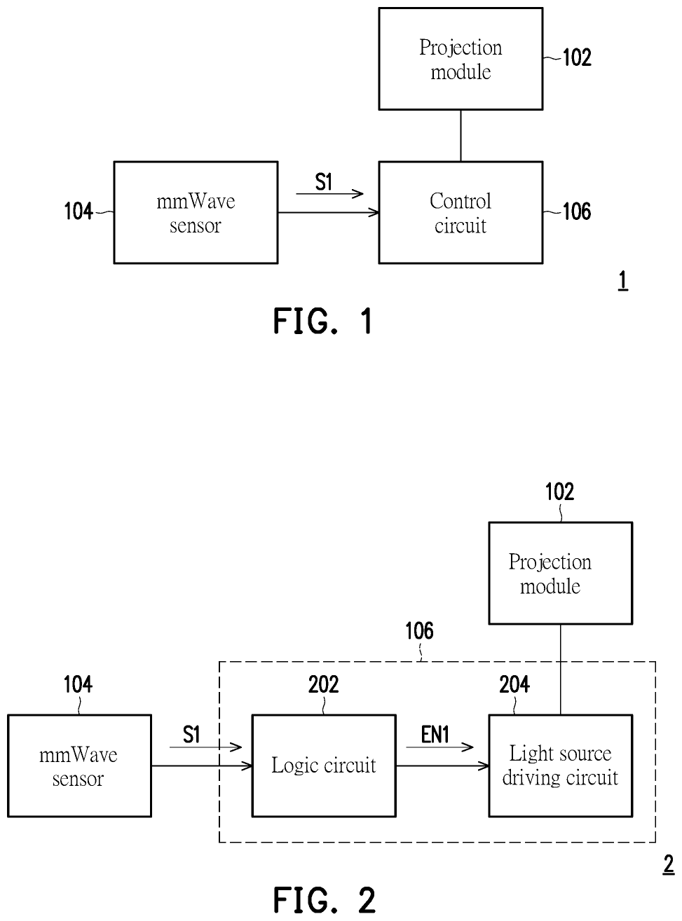

FIG. 1 is a schematic diagram of a projection system according to an embodiment of the invention. Please refer to FIG. 1. The projection system includes a projection module 102, a mmWave sensor 104, and a control circuit 106. The control circuit 106 is coupled to the projection module 102 and the mmWave sensor 104. The projection module 102 is configured to project an image beam to a projection surface. Further, the projection module 102 may include a light source (not shown) and a light valve (not shown). The light source may be configured to provide an illumination beam to the light valve, and the light valve is configured to convert the illumination beam into an image beam. The mmWave sensor 104 is configured to sense whether an object (such as people or animals) enters the sensing range of the mmWave sensor 104 and obtain a sensing result 51. The control circuit 106 is configured to control the projection module 102 to provide the image beam according to the sensing result 51 of the mmWave sensor 104. The sensing range is, for example, the projection range of the image beam projected from the projection module 102 to the projection surface. For example, the mmWave sensor 104 may sense a range within a distance of 4 meters and an angle of 120 degrees, for example, the distance and the angle may be adjusted according to actual needs, and the invention is not limited thereto. When the mmWave sensor 104 does not sense that an object enters the sensing range thereof, the control circuit 106 may control the projection module 102 to output the image beam normally to display a projection image. When the mmWave sensor 104 senses that an object enters the sensing range thereof, the control circuit 106 may control the projection module 102 to stop outputting the image beam. More specifically, the control circuit 106 controls the light source in the projection module 102 to stop providing the illumination beam, so that the projection module 102 stops outputting the image beam, thereby preventing the image beam from causing damage to the eyes of people entering the sensing range of the mmWave sensor 104, thus improving the use safety of the projection system.

In the present embodiment, the mmWave sensor 104 may detect subtle distance changes, for example, may detect distance changes in which the chest of a person or an animal rises and falls due to breathing. Therefore, even if people or animals do not move significantly within the sensing range, they may still be detected by the mmWave sensor 104, so that the control circuit 106 turns off the light source of the projection module 102.

In addition, in some embodiments, the mmWave sensor 104 may have a state indication value indicating whether the mmWave sensor 104 is abnormal. The control circuit 106 may determine whether the state of the mmWave sensor 104 is abnormal according to the state indication value. The control circuit 106 may control the projection module 102 to provide the image beam according to the state indication value and the sensing result Si of the mmWave sensor 104. For example, when the state of the mmWave sensor 104 is abnormal, or the sensing result of the mmWave sensor 104 is that the object enters the sensing range, the control circuit 106 may control the projection module 102 to stop providing the image beam.

FIG. 2 is a schematic diagram of a projection system according to another embodiment of the invention. The difference between a projection system 2 of FIG. 2 and the projection system 1 of FIG. 1 is that the control circuit 106 of FIG. 2 may include a logic circuit 202 and a light source driving circuit 204. The logic circuit 202 is coupled to the mmWave sensor 104 and the light source driving circuit 204. The light source driving circuit 204 is coupled to the projection module 102. The logic circuit 202 is configured to output an enable control signal EN1 according to the sensing result Si of the mmWave sensor 104. The light source driving circuit 204 is configured to drive the projection module 102 to provide the image beam according to the enable control signal EN1. More specifically, for example, the light source driving circuit 204 may drive the light source in the projection module 102 to provide the illumination beam to the light valve according to the enable control signal EN1, so that the projection module 102 provides the image beam to the projection surface.

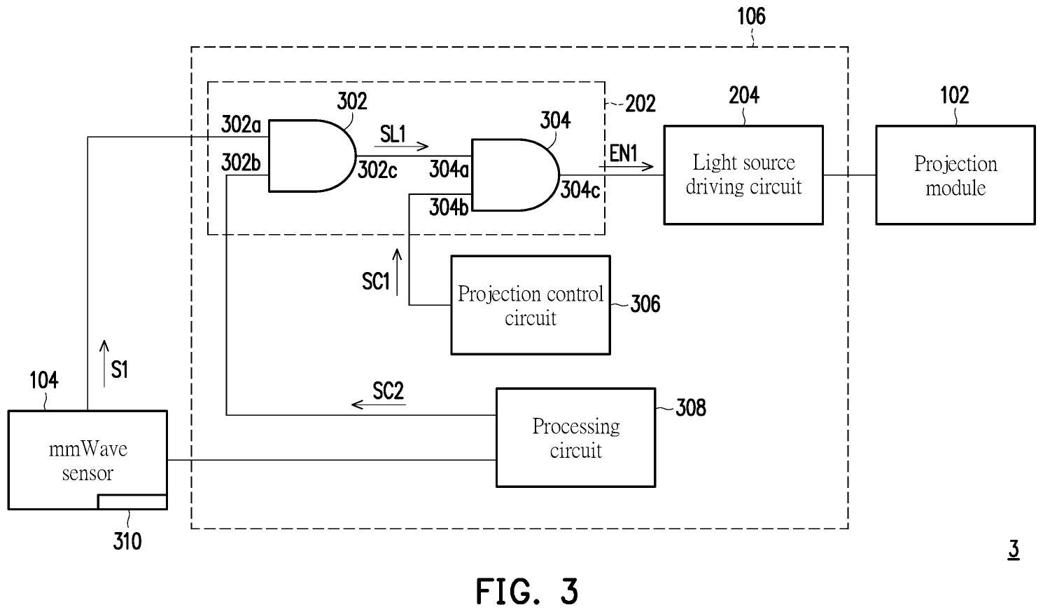

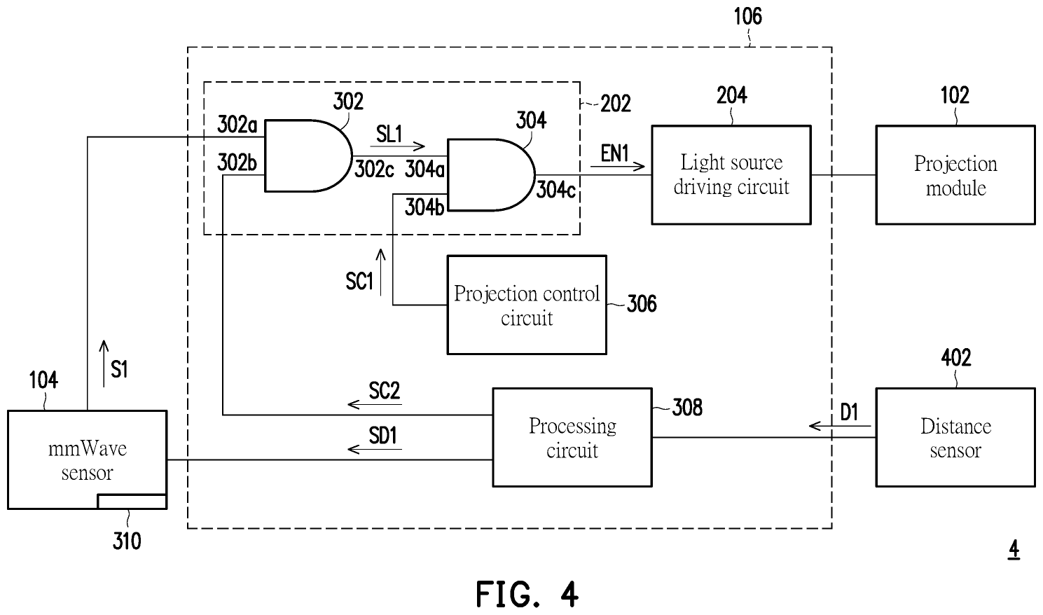

In detail, the implementation of the control circuit 106 may be as shown in FIG. 3. FIG. 3 is a schematic diagram of a projection system according to another embodiment of the invention. The difference between a projection system 3 of FIG. 3 and the projection system 2 of FIG. 2 is that the logic circuit 202 of FIG. 3 may include, for example, a first AND gate 302 and a second AND gate 304, and the control circuit 106 may also include a projection control circuit 306 and a processing circuit 308. In particular, the projection control circuit 306 may be implemented by, for example, a digital data processor (DDP), and the processing circuit 308 may be implemented by, for example, a scaler IC, but not limited thereto. In addition, the first AND gate 302, the second AND gate 304, the projection control circuit 306, and the processing circuit 308 may be disposed on the same circuit board or on different circuit boards according to design requirements. The first AND gate 302 has an input terminal 302a, an input terminal 302b, and an output terminal 302c. The input terminal 302a of the first AND gate 302 is coupled to the mmWave sensor 104, and the input terminal 302b is coupled to the processing circuit 308. The second AND gate 304 has an input terminal 304a, an input terminal 304b, and an output terminal 304c. The input terminal 304a of the second AND gate is coupled to the output terminal 302c of the first AND gate 302, the input terminal 304b is coupled to the projection control circuit 306, and the output terminal 304c is coupled to the light source driving circuit 204. The processing circuit 308 is coupled to the mmWave sensor 104. The first AND gate 302 may output a logic signal SL1 according to the sensing result Si provided by the mmWave sensor 104 and a control signal SC2 provided by the processing circuit 308. The second AND gate 304 may output the enable control signal EN1 according to the logic signal SL1 and a control signal SC1 provided by the projection control circuit 306. In particular, the control signal SC2 is generated according to the state of the mmWave sensor 104. Specifically, the mmWave sensor 104 may have a register 310 storing the state indication value. The processing circuit 308 may read the state indication value of the mmWave sensor 104 and output the control signal SC2 according to the state indication value. For example, when the working state of the mmWave sensor 104 is abnormal, the state indication value is, for example, “0”. When the working state of the mmWave sensor 104 is normal, the state indication value is, for example, “1”.

Specifically, when the state indication value indicates that the mmWave sensor 104 is abnormal, the processing circuit 308 may provide the control signal SC2 of a low voltage level to the first AND gate 302 according to the state indication value. Or, when the sensing result 51 of the mmWave sensor 104 is that an object enters the sensing range, the mmWave sensor 104 may provide a low voltage level signal to the first AND gate 302 according to the sensing result 51. Then, the first AND gate 302 outputs the logic signal SL1 of a low voltage level to the second AND gate 304 according to the sensing result 51 or the control signal SC2. The second AND gate 304 then outputs the enable control signal EN1 of a low voltage level to the light source driving circuit 204, so that the light source of the projection module 102 is turned off. Therefore, the projection module 102 may be prevented from providing an image beam when the mmWave sensor 104 is abnormal or an object enters the sensing range. In contrast, when the mmWave sensor 104 is not abnormal, the processing circuit 308 may provide the control signal SC2 of a high voltage level to the first AND gate 302 according to the state indication value. Moreover, when the sensing result 51 of the mmWave sensor 104 is that no object enters the sensing range, the mmWave sensor 104 may provide a high voltage level signal to the first AND gate 302 according to the sensing result 51. Then, the first AND gate 302 outputs the logic signal SL1 of a high voltage level to the second AND gate 304 according to the sensing result 51 and the control signal SC2.

Moreover, the control signal SC1 is generated according to the working state of the projection module 102. Further, the projection control circuit 306 is configured to control the projection module 102 to perform projection-related operations, such as controlling the operation of elements such as the light source and the light valve of the projection module 102, in order to make the projection module 102 provide the illumination beam and the image beam and the like at the correct timing. The projection control circuit 306 enables the light source driving circuit 204 to drive the light source of the projection module 102 to provide the illumination beam to the light valve at the proper time via the control signal SC1, so that the projection module 102 may provide the correct image beam. In other words, even if the logic signal SL1 is in the state of allowing the image beam to be provided (the logic signal SL1 of a high voltage level), the projection control circuit 306 still needs to determine that the control time sequence of the projection operation enters the time point at which the image beam may be provided, and provide the corresponding control signal SC1 (for example, the control signal SC1 of a high voltage level) to the second AND gate 304, so that the light source driving circuit 204 may drive the projection module 102 to provide the image beam according to the enable control signal EN1 of a high voltage level provided by the second AND gate 304. The image beam is prevented from being provided when the working state of the projection module 102 is abnormal. Since in the present embodiment, the light source of the projection module 102 is turned off via a hardware (the logic circuit 202 and the light source driving circuit 204), the sensing result of the sensor does not need to be determined via the software or program of the processing circuit 308 (e.g., a scaling control chip or a microcontroller). Therefore, when the projection system 3 of the present embodiment senses that the object enters the sensing range, the response time for turning off the light source is very short, and the light source may be turned off within 200 ms.

FIG. 4 is a schematic diagram of a projection system according to another embodiment of the invention. The difference between a projection system 4 of FIG. 4 and the projection system 3 of FIG. 3 is that the projection system 4 further includes a distance sensor 402 coupled to the processing circuit 308. The distance sensor 402 may be, for example, an infrared sensor, a proximity sensor, a camera, a laser distance sensor, or a time of flight (ToF) sensor, but is not limited thereto. The distance sensor 402 is configured to sense the distance between the projection module 102 and the projection surface, and output a distance sensing signal D1 to the processing circuit 308. The processing circuit 308 may output a distance signal SD1 to the mmWave sensor 104 according to the distance sensing signal D1. The mmWave sensor 104 adjusts the sensing range thereof according to the distance signal SD1.

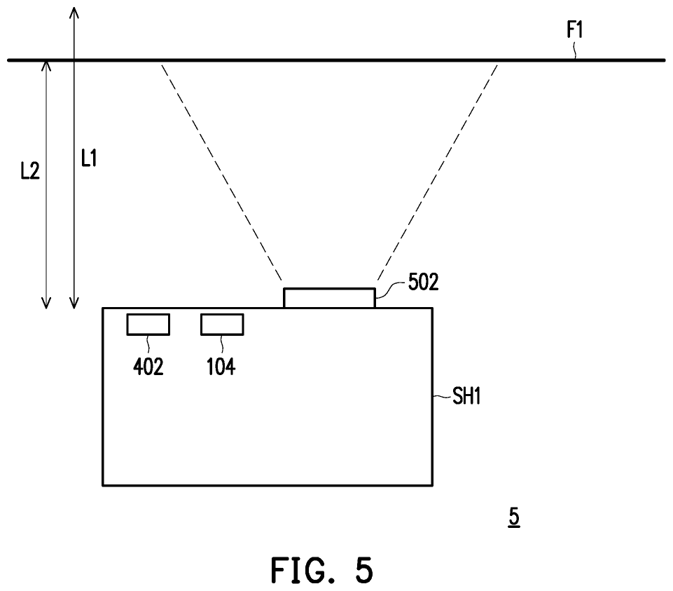

For example, as shown in FIG. 5, FIG. 5 is a schematic diagram of adjusting a sensing range of a mmWave sensor according to an embodiment of the invention. The sensing beam of the mmWave sensor 104 has the property of penetrating objects (e.g., a projection surface F1 such as a screen or a wall). Assuming that the sensing range of the mmWave sensor 104 of a projection system 5 before adjustment may reach a sensing distance L1, the sensing range may reach the rear of the projection surface F1. That is, the sensing range is greater than the projection range of the image beam projected from a projection lens 502 to the projection surface F1. In this way, when an object enters the sensing range behind the projection surface F1 such as a screen or a wall, the projection system 5 also stops providing the image beam. However, the object (a person or an animal) appearing at the rear of the projection surface F1 is not irradiated by the image beam that causes damage to the eyes, and therefore the sensing range of the mmWave sensor 104 needs to be adjusted. The distance sensor 402 senses that the sensing distance between the projection module 102 (shown in FIG. 4) and the projection surface F1 is L2. The mmWave sensor 104 adjusts the sensing distance L1 (for example, 4 meters) to the sensing distance L2 (for example, 3 meters) according to the distance signal SD1 (shown in FIG. 4), so that the sensing range of the mmWave sensor 104 is made equal to the area between the projection lens 502 and the projection surface F1, so as to avoid the projection system 5 from unnecessarily stopping providing the image beam.

Since the sensing distance of the mmWave sensor 104 is positively correlated with the magnitude of the transmission power, the mmWave sensor 104 may include, for example, a comparison table between the sensing distance and the transmission power, and the mmWave sensor 104 may adjust the transmission power according to the distance signal SD1, so that the mmWave sensor 104 may adjust the sensing range according to the transmission power. In other embodiments, instead of adjusting the transmission power of the mmWave sensor 104 to adjust the sensing range, the mmWave sensor 104 may choose to ignore the sensing results 51 outside the predetermined sensing range. For example, the sensing distance between the projection module 102 and the projection surface F1 is 1 meter. Even if the sensing distance of the mmWave sensor 104 is greater than 1 meter, the mmWave sensor 104 may still exclude the sensing result 51 having a sensing distance greater than 1 meter via an internal algorithm. That is, the mmWave sensor 104 does not send the logic signal SL1 of a low voltage level to the first AND gate 302 according to the sensing result 51 having a sensing distance greater than 1 meter. This prevents the projection system 5 from unnecessarily stopping providing the image beam. With the setting of the distance sensor 402, the distance sensor 402 may detect the sensing distance between the projection module 102 and the projection surface F1 in real time, so that the mmWave sensor 104 may dynamically adjust the sensing range.

Returning to FIG. 4 again, in some embodiments, in addition to the processing circuit 308 adjusting the sensing range of the mmWave sensor 104 according to the distance signal SD1, the projection system 4 may also include, for example, an operation interface for adjusting the sensing range. The control circuit 106 may adjust the sensing range of the mmWave sensor 104 according to a sensing range adjustment command corresponding to the user's input operation, so that the sensing range of the mmWave sensor 104 meets the needs of the user. In addition, in FIG. 5, the projection system 5 further includes a casing SH1 and the projection lens 502. The mmWave sensor 104 and the distance sensor 402 are disposed in the casing SH1 of the projection system 5, for example, may be disposed on the same side as the projection lens 502 of the projection system 5. In particular, since the sensing beam of the mmWave sensor 104 has the property of penetrating objects, there is no need to set an opening corresponding to the mmWave sensor 104 on the casing SH1, so that the appearance of the projection system 5 may be kept simple and manufacturing cost may be reduced.

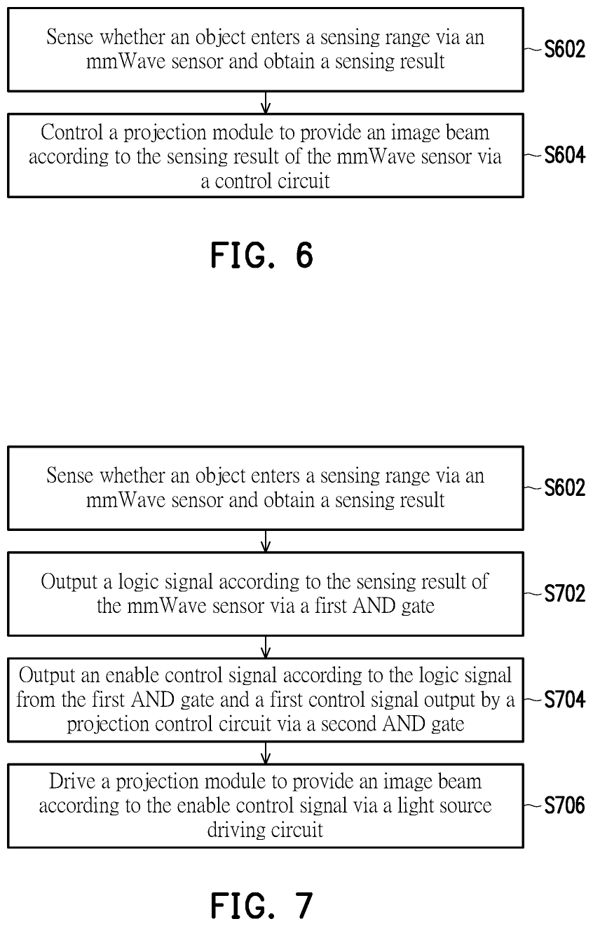

FIG. 6 is a flowchart of a control method of a projection system according to an embodiment of the invention. It may be known from the above embodiments of FIG. 1 to FIG. 5 that the control method of the projection system may include the following steps. First, in step S602, the mmWave sensor 104 senses whether an object enters a sensing range, and obtains the sensing result S1. Next, in step S604, the projection module 102 is controlled to provide an image beam according to the sensing result Si of the mmWave sensor 104 via the control circuit 106.

Further, the projection system 2 may include the logic circuit 202 and the light source driving circuit 204, and the logic circuit 202 may have the first AND gate 302 and the second AND gate 304. The control method of the projection system may be shown in FIG. 7. After step S602, in step S702, the logic signal SL1 is output according to the sensing result Si of the mmWave sensor 104 via the first AND gate 302. Then, in step S704, the enable control signal EN1 is output according to the logic signal SL1 from the first AND gate 302 and the first control signal SC1 output from the projection control circuit 306 via the second AND gate 304. Next, in step S706, the projection module 102 is driven to provide the image beam according to the enable control signal EN1 via the light source driving circuit 204.

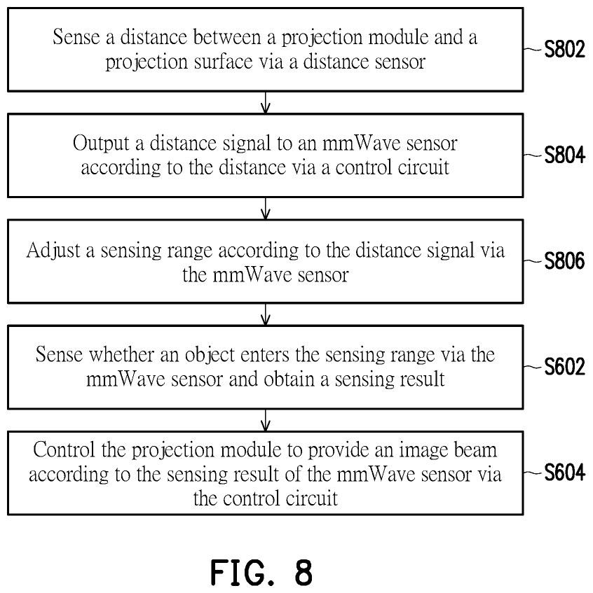

In some embodiments, the projection system 4 may also include a distance sensor 402. The control method of the projection system is shown in FIG. 8. In step S802, a distance between the projection module 102 and the projection surface F1 is first sensed by the distance sensor 402. Then in step S804, the distance signal SD1 is output to the mmWave sensor 104 according to the distance via the control circuit 106. Next, in step S806, a sensing range is adjusted according to the distance signal SD1 via the mmWave sensor 104, and after the adjustment of the mmWave sensor 104 is completed, step S602 to step S604 of FIG. 6 or step S602 to step S706 of FIG. 7 may be performed, to perform the step of sensing whether an object enters the sensing range and the step of controlling the projection module 102 to provide an image beam according to the sensing result Si.

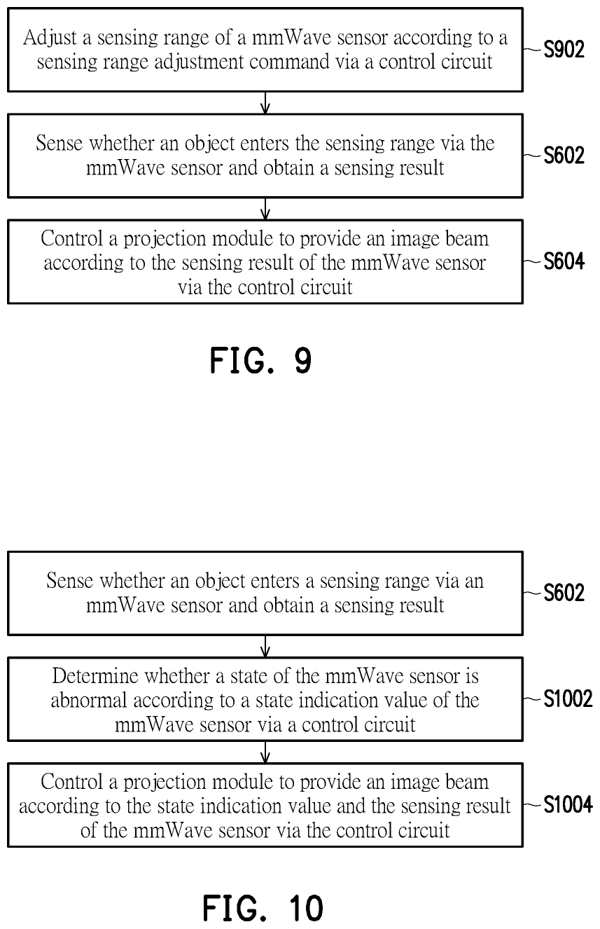

In some embodiments, as shown in FIG. 9, in step S902, the sensing range of the mmWave sensor 104 may also be adjusted according to a sensing range adjustment command via the control circuit 106, to adjust the sensing range to the sensing range specified by the user, and then step S602 to step S604 of FIG. 6 or step S602 to S706 of FIG. 7 may be performed, to perform the step of sensing whether an object enters the sensing range and the step of controlling the projection module 102 to provide an image beam according to the sensing result Si.

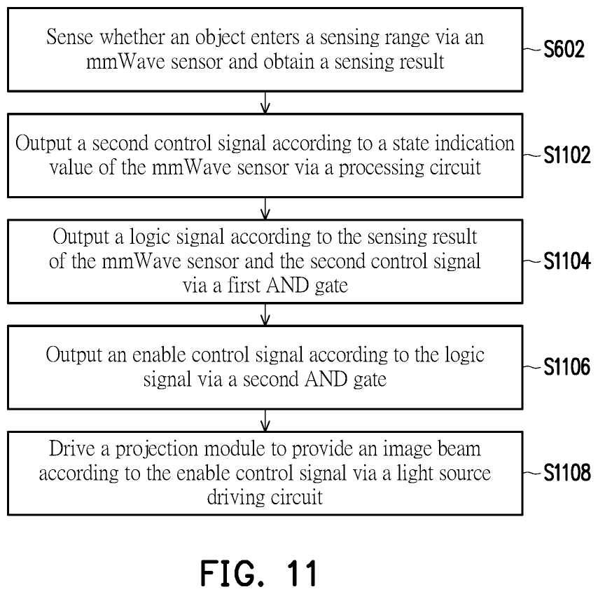

In addition, in some embodiments, as shown in FIG. 10 or FIG. 11, whether to provide the image beam may also be determined according to whether the mmWave sensor 104 is abnormal. As shown in FIG. 10, after step S602, in step S1002, whether the state of the mmWave sensor 104 is abnormal may be determined according to a state indication value of the mmWave sensor 104 via the control circuit 106. Next, in step S1004, the projection module 102 is controlled to provide the image beam according to the state indication value and the sensing result Si of the mmWave sensor 104 via the control circuit 106. Further, as shown in FIG. 11, after step S602, in step S1102, the second control signal SC2 may first be output according to the state indication value of the mmWave sensor 104 via the processing circuit. Then in step S1104, the logic signal SL1 is output according to the sensing result Si of the mmWave sensor 104 and the second control signal SC2 via the first AND gate 302. Then, in step S1106, the enable control signal EN1 is output according to the logic signal SL1 via the second gate 304. Next, in step S1108, the projection module 102 is driven to provide the image beam according to the enable control signal EN1 via the light source driving circuit 204.

Based on the above, the control circuit 106 of the invention may control the projection module 102 to provide the image beam according to the sensing result Si of the mmWave sensor 104. When a person or an animal enters the sensing range of the mmWave sensor 104, the control circuit 106 may control the projection module 102 to stop providing the image beam, so as to prevent the image beam from causing damage to the eyes of humans or animals, thereby improving the use safety of the projection system.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection system, comprising:
a projection module configured to project an image beam to a projection surface;
an mmWave sensor configured to sense an object entering a sensing range and obtain a sensing result; and
a control circuit coupled to the projection module and the mmWave sensor, and the control circuit is configured to control the projection module to provide the image beam according to the sensing result of the mmWave sensor.

2. The projection system according to claim 1, wherein the control circuit comprises:
a logic circuit coupled to the mmWave sensor, and the logic circuit is configured to output an enable control signal according to the sensing result of the mmWave sensor; and
a light source driving circuit coupled to the logic circuit and the projection module, and the light source driving circuit is configured to drive the projection module to provide the image beam according to the enable control signal.

3. The projection system according to claim 2, wherein the logic circuit comprises:
a first AND gate comprising a first input terminal and a first output terminal, the first input terminal is coupled to the mmWave sensor, and the first AND gate is configured to output a logic signal according to the sensing result of the mmWave sensor; and
a second AND gate comprising a second input terminal and a second output terminal, the second input terminal is coupled to the first output terminal of the first AND gate, the second output terminal is coupled to the light source driving circuit, and the second AND gate is configured to output the enable control signal according to the logic signal.

4. The projection system according to claim 3, wherein the second AND gate further comprises a third input terminal, and the control circuit further comprises:
a projection control circuit coupled to the projection module and the third input terminal, the projection control circuit is configured to output a first control signal to the second AND gate according to a working state of the projection module, and the second AND gate outputs the enable control signal according to the logic signal from the first AND gate and the first control signal.

5. The projection system according to claim 1, further comprising:
a distance sensor coupled to the control circuit and configured to sense a distance between the projection module and the projection surface, the control circuit outputs a distance signal to the mmWave sensor according to the distance, and the mmWave sensor adjusts the sensing range from a first sensing range to a second sensing range according to the distance signal.

6. The projection system according to claim 5, wherein the mmWave sensor adjusts a transmission power from a first transmission power to a second transmission power according to the distance signal.

7. The projection system according to claim 1, wherein the control circuit adjusts the sensing range of the mmWave sensor according to a sensing range adjustment command.

8. The projection system according to claim 1, wherein the mmWave sensor has a state indication value, the control circuit is configured to determine whether a state of the mmWave sensor is abnormal according to the state indication value, and the control circuit controls the projection module to provide the image beam according to the state indication value and the sensing result of the mmWave sensor.

9. The projection system according to claim 8, wherein the control circuit controls the projection module to stop providing the image beam when the state of the mmWave sensor is abnormal, or the sensing result of the mmWave sensor is that the object enters the sensing range.

10. The projection system according to claim 8, wherein the control circuit comprises:
a processing circuit coupled to the mmWave sensor, and the processing circuit is configured to output a second control signal according to the state indication value;
a logic circuit coupled to the mmWave sensor and the processing circuit, and the logic circuit is configured to output an enable control signal according to the sensing result of the mmWave sensor and the second control signal; and
a light source driving circuit coupled to the logic circuit and the projection module, and the light source driving circuit is configured to drive the projection module to provide the image beam according to the enable control signal.

11. The projection system according to claim 10, wherein the logic circuit comprises:
a first AND gate comprising a first input terminal, a fourth input terminal, and a first output terminal, the first input terminal is coupled to the mmWave sensor, the fourth input terminal is coupled to the processing circuit, and the first AND gate is configured to output a logic signal according to the sensing result of the mmWave sensor and the second control signal; and
a second AND gate comprising a second input terminal and a second output terminal, the second input terminal is coupled to the first output terminal of the first AND gate, the second output terminal is coupled to the light source driving circuit, and the second AND gate is configured to output the enable control signal according to the logic signal.

12. The projection system according to claim 8, wherein the mmWave sensor comprises a register, and the register is configured to store the state indication value.

13. The projection system according to claim 1, further comprising:
a casing, the mmWave sensor is disposed in the casing, and the casing does not have an opening corresponding to a position where the mmWave sensor is disposed.

14. A control method of a projection system, comprising:
sensing whether an object enters a sensing range via a mmWave sensor, and obtaining a sensing result; and
controlling a projection module to provide an image beam according to the sensing result of the mmWave sensor via a control circuit.

15. The control method of the projection system according to claim 14,
wherein the control circuit comprises a logic circuit and a light source driving circuit, and the control method of the projection system comprises:
outputting an enable control signal according to the sensing result of the mmWave sensor via the logic circuit; and
driving the projection module to provide the image beam according to the enable control signal via the light source driving circuit.

16. The control method of the projection system according to claim 15, wherein the logic circuit comprises a first AND gate and a second AND gate, and the control method of the projection system comprises:
outputting a logic signal according to the sensing result of the mmWave sensor via the first AND gate; and
outputting the enable control signal according to the logic signal via the second AND gate.

17. The control method of the projection system according to claim 16, wherein the control circuit further comprises a projection control circuit, and the control method of the projection system comprises:
outputting a first control signal to the second gate AND gate according to a working state of the projection module via the projection control circuit; and
outputting the enable control signal according to the logic signal from the first AND gate and the first control signal via the second AND gate.

18. The control method of the projection system according to claim 14, comprising:
sensing a distance between the projection module and a projection surface via a distance sensor;
outputting a distance signal to the mmWave sensor according to the distance via the control circuit; and
adjusting the sensing range from a first sensing range to a second sensing range according to the distance signal via the mmWave sensor.

19. The control method of the projection system according to claim 18, comprising:
adjusting a transmission power from a first transmission power to a second transmission power according to the distance signal via the mmWave sensor.

20. The control method of the projection system according to claim 14, comprising:
adjusting the sensing range of the mmWave sensor according to a sensing range adjustment command via the control circuit.

21. The control method of the projection system according to claim 14, comprising:
determining whether a state of the mmWave sensor is abnormal according to a state indication value of the mmWave sensor via the control circuit; and
controlling the projection module to provide the image beam according to the state indication value and the sensing result of the mmWave sensor via the control circuit.

22. The control method of the projection system according to claim 21, comprising:
controlling the projection module to stop providing the image beam via the control circuit when the state of the mmWave sensor is abnormal, or the sensing result of the mmWave sensor is that the object enters the sensing range.

23. The control method of the projection system according to claim 21, wherein the control circuit comprises a processing circuit, a logic circuit, and a light source driving circuit, and the control method of the projection system comprises:
outputting a second control signal according to the state indication value via the processing circuit;
outputting an enable control signal according to the sensing result of the mmWave sensor and the second control signal via the logic circuit; and
driving the projection module to provide the image beam according to the enable control signal via the light source driving circuit.

24. The control method of the projection system according to claim 23, wherein the logic circuit comprises a first AND gate and a second AND gate, and the control method of the projection system comprises:
outputting a logic signal according to the sensing result of the mmWave sensor and the second control signal via the first AND gate; and
outputting the enable control signal according to the logic signal via the second AND gate.
